(19) United States
(12) Patent Application Publication
(10) Pub. No.: US 2019/0330896 A1
(43) Pub. Date: Oct. 31, 2019

(54) GUIDE SYSTEM FOR GUIDING A MOVABLY MOUNTED FURNITURE PART

(71) Applicant: Julius Blum GmbH, Hoechst (AT)

(72) Inventors: Matthias RUPP, Hohenweiler (AT); Christian HAUER, Hoerbranz (AT); Hermann HAEMMERLE, Lustenau (AT); Ingo GASSER, Hoechst (AT)

(21) Appl. No.: 16/509,011

(22) Filed: Jul. 11, 2019

Related U.S. Application Data
(63) Continuation of application No. PCT/AT2017/060348, filed on Dec. 22, 2017.

(30) Foreign Application Priority Data
Jan. 13, 2017 (AT) A 50024/2017

(51) Int. Cl. E05D 15/26; E05D 15/58; E06B 3/48; E05D 15/36

(52) U.S. Cl. CPC E05D 15/264; E05D 15/58; E05Y 2900/212; E05D 15/36; E06B 3/482

(57) ABSTRACT

A guide system for guiding a movably mounted furniture part, in particular a folding or folding-sliding door, includes a longitudinal guide rail, at least one guide device via which the furniture part is movable in a longitudinal direction along the longitudinal guide rail, and at least one support on which the furniture part is mounted in an articulated manner. The at least one support is movable in a direction extending transversely to the longitudinal direction of the longitudinal guide rail, and the at least one support has a receiving device for receiving the guide device and the support is movable in the mounted position into a transfer position in which the receiving device is arranged adjacent to the longitudinal guide rail. A compensation device compensates for a height difference between the receiving device and the longitudinal guide rail is provided.

### BACKGROUND OF THE INVENTION

The invention concerns a guide system and an article of furniture having a guide system according to the invention.

Guide systems of the kind set forth in the opening part of this specification are already part of the state of the art and are disclosed for example in EP 2 740 870 A1. Such guide systems are capable of moving furniture parts arranged thereon, for example in the form of folding doors or folding-sliding doors, between an open position and a closed position, and compensating for a heightwise play occurring upon movement of an article of furniture. That heightwise play acts as a height difference between the moveable furniture part and the body of the article of furniture as soon as it moves from the closed position into an open position. That heightwise play is necessary for example in order to be able to adjust for example doors or sliding doors or leaf doors which are arranged moveably to the body of the article of furniture or the like, or to achieve higher degrees of freedom in regard to movement of the moveable furniture part. For example moveable furniture parts must be able to move in the closed position into a body of an article of furniture without involving a collision and/or must also present a uniform gap formation in regard to other moveable furniture parts or the body of the article of furniture. Therefore the moveable furniture parts in the closed position of the article of furniture (for example when all doors, folding doors or folding-sliding doors are closed) must be correctly positioned, which in the state of the art is effected by centring devices directly in the hinges. In the closed position so-to-speak the moveable furniture part is moved into the desired position by the hinge by way of those centring devices. In that case the hinge cup arranged in the hinge has inclined centring surfaces which contact the arm of the hinge during the closing movement and thus centre it or move it into the desired position without heightwise play. In that case, however, centring is effected by direct contact between the hinge arm and the hinge cup at comparatively small centring surfaces. The entire weight of the moveable hinge parts acts on those surfaces. After the furniture parts have been opened and closed a frequent number of times it can therefore happen that problems can occur due to the small centring surfaces and the relatively high surface pressure on those small surfaces. Those problems are for example surface damage to the centring surfaces which can occur for example solely due to the friction between the arm and the centring surfaces and also due to the friction in combination with contamination like dust or metal abrasion particles. Such surface damage can subsequently result in limitations in the mobility or ease of movement of the hinge and as a further consequence, for example when the hinge becomes jammed in its movement, it can also lead to damage to the entire article of furniture. In addition the frictional contact of the centring surfaces can give rise to troublesome noise. With increasing wear of those surfaces, adjustment of the gap dimension also becomes increasingly poor.

### SUMMARY OF THE INVENTION

The object of the invention is to avoid the above-described disadvantages and to provide a guide system which is improved over the state of the art and an article of furniture having such a guide system.

If the at least one support has a receiving device for receiving the guide device and the support is moveable in the mounted position into a transfer position in which the receiving device is arranged adjacent to the longitudinal guide rail and there is provided a compensation device for compensating for a height difference between the receiving device and the longitudinal guide rail then the height difference or heightwise play is compensated by sturdy components and not by centering surfaces of small dimensions on a hinge cup. The force due to the weight of the moveable furniture part is distributed to a larger area and in addition does not have to be deflected by way of inclined surfaces, as is the case with the centering surfaces. In the case of the guide system according to the invention the main loading is transmitted to components which are already very sturdy and which have a load-bearing function and are not provided for the task of pivoting the moveable furniture part between two positions, as is the case with a cup-type hinge. In other words: lifting or compensating for the height difference is effected directly by way of load-bearing components of the guide system and not indirectly by way of the movement at the hinges. Those guide systems are provided by rails or profile members which by virtue of their intended function are of larger dimensions than for example hinges. Furthermore, those rails moveably carry a guide device which for example is mounted on rollers and can be more sturdy than a cup-type hinge. That structure for the entire guide system provides a longer service life, a higher level of stability, greater reliability and smooth-running movement with a low level of noise.

Further details and advantages of the present invention will be apparent from the features of the appendant claims.

### BRIEF DESCRIPTION OF THE DRAWINGS

Further details and advantages of the present invention are described more fully hereinafter by means of the specific description with reference to the embodiments by way of example illustrated in the drawings in which:

FIGS. 1a-1c show different positions of the moveable furniture part on the furniture body,

FIG. 2 shows an article of furniture with opened door leaves shortly before the transfer position,

FIG. 3 is a detail view from FIG. 2,

FIG. 4 is a simplified view of the guide system,

FIG. 5 shows the guide device on the longitudinal guide rail,

FIG. 6 is a diagrammatic view illustrating the guide system and moveable furniture parts,

FIG. 7 shows the guide system with furniture parts set free, and

FIG. 8 is a detail view from FIG. 7.

### DETAILED DESCRIPTION OF THE INVENTION

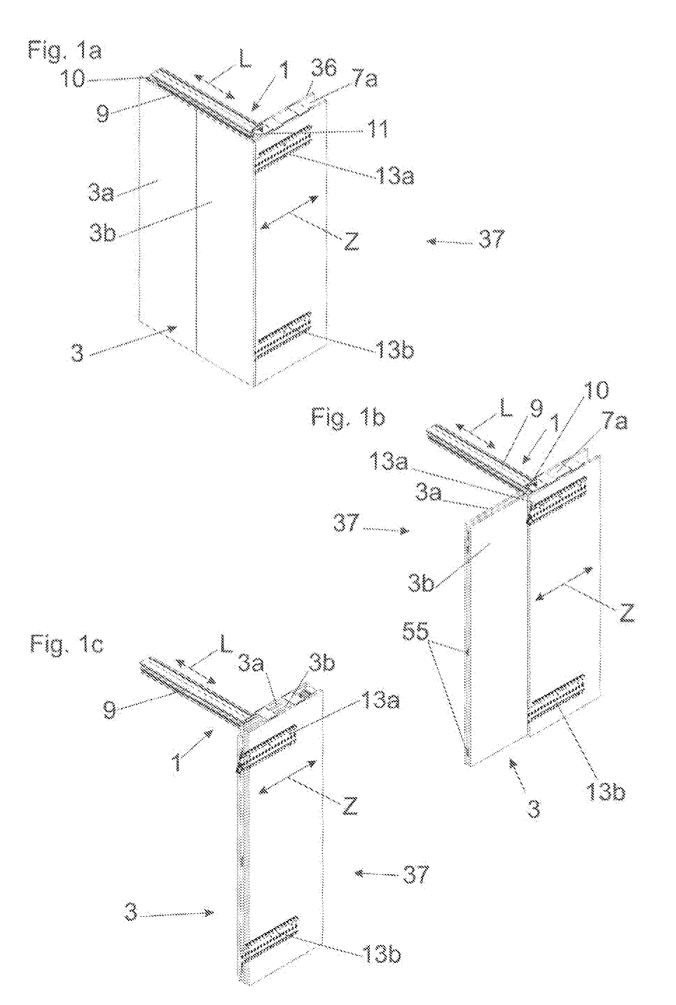

FIG. 1a shows a guide system 1 for guiding a moveably mounted furniture part 3, in particular a folding or folding-sliding door, including a longitudinal guide rail 9 arranged in the upper region of the article of furniture 37 and at least one guide device 10, by way of which the furniture part 3 is moveable in a longitudinal direction L, along the longitudinal guide rail 9.

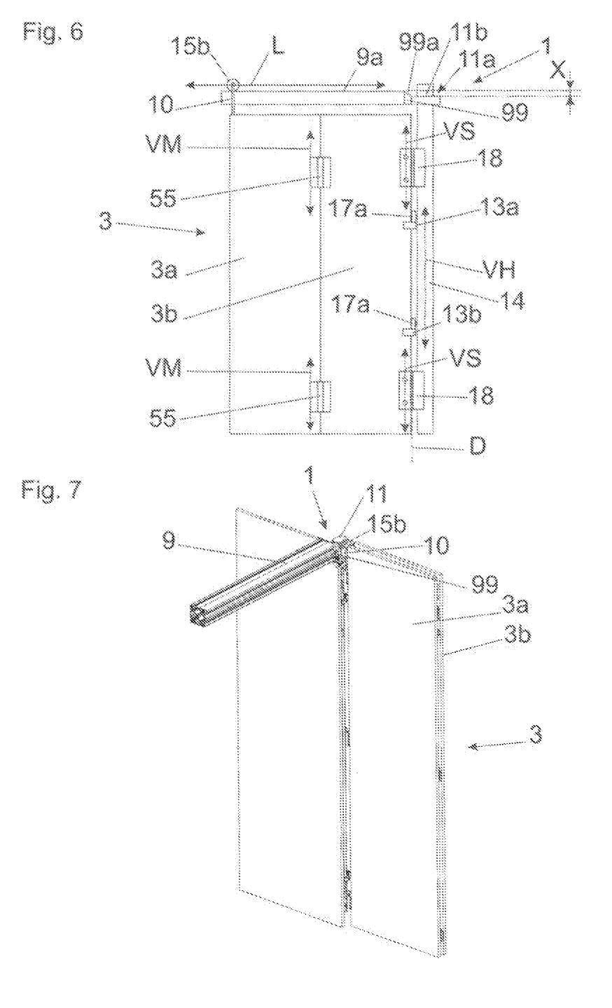

In addition the guide system 1 has a support 11 which is intended for receiving the guide device 10 as soon as it is moved into the open position of the door leaves 3a, 3b (see FIG. 1b). In addition, the furniture part 3 is mounted hingedly to the support 11 or in the region beneath the support by way of fitments 18 (see FIG. 6), wherein the support 11 is displaceable in a direction Z extending transversely relative to the longitudinal direction L of the longitudinal guide rail 9.

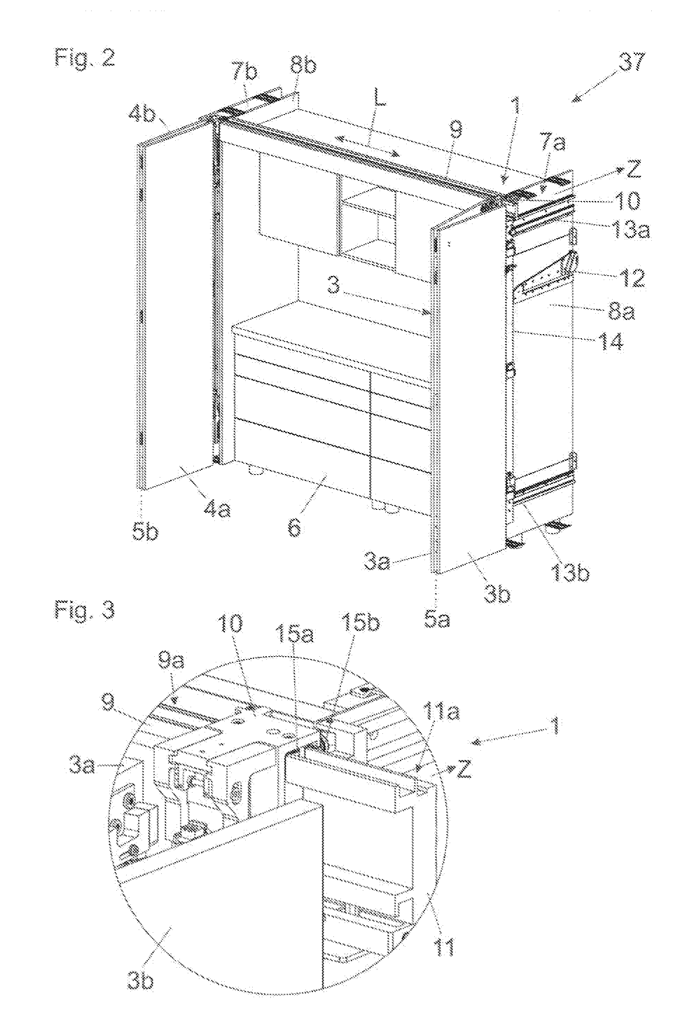

The article of furniture 37 has a furniture body or carcass 36 which is fixed in operation and at least two furniture parts 3 mounted moveably relative to the furniture body 36, in particular door leaves 3a, 3b of a folding or folding-sliding door. They are hingedly connected together in the mounted position by way of a vertically extending axis of rotation 5a (see FIG. 2). In that respect the at least two furniture parts 3 or in other words the door leaves 3a, 3b are moveable by the guide system 1 between a first position in which the door leaves 3a, 3b are oriented in substantially mutually coplanar relationship, and a second position in which the door leaves 3a, 3b are oriented in substantially mutually parallel relationship. The parallel orientation is shown in FIG. 1c.

FIG. 1a shows the closed position. FIG. 1b shows an open position and FIG. 1c shows an insertion position in which the at least one moveable furniture part 3 has been pushed into an insertion shaft 7a.

In FIG. 1b the furniture part 3, in this example afforded by two mutually moveable leaf doors 3a, 3b, has already been moved in a longitudinal direction L along the longitudinal guide rail 9 and is disposed in front of the insertion shaft 7a. In that case the door leaves 3a, 3b are arranged substantially or almost parallel to each other to find space in the insertion shaft 7a.

The door leaf 3b or the furniture part 3 is in that case fixed at at least one fitment 18 moveably about an axis of rotation D at a column 14 (not visible). The column 14 is shown in FIG. 6.

The second door leaf 3a is mounted displaceably by means of a guide device 10 along the longitudinal guide rail 9. The furniture part 3, the two door leaves 3a, 3b, can be pushed out of the closed position shown in FIG. 1b into the insertion shaft 7a, as is shown in FIG. 1c. In that case the guide device 10 is received in the support 11. The guide device 10 therefore is no longer in contact with the longitudinal guide rail 9.

FIG. 1c shows how the furniture part 3 or the door leaves 3a, 3b have been pushed into the insertion shaft 7a by way of the insertion rails 13b. It is thus provided that the guide system 1 has at least one insertion rail 13a, 13b, along which the at least one support 11 or a column 14 arranged on the support is moveable in a direction Z extending transversely relative to the longitudinal direction L of the longitudinal guide rail 9. Thus it is possible for the moveable furniture parts 3 to be stowed in space-saving fashion.

FIG. 2 shows a possible application of a guide system 1 for guiding a furniture part 3, preferably in the form of a first door leaf 3b of a folding door or folding-sliding door, wherein the first door leaf 3b in the mounted position is connected to a second door leaf 3a by way of a vertically extending axis 5a. Optionally, there can also be provided at least two further door leaves 4a, 4b which are also pivotably connected together by way of a vertical extending axis 5b.

The guide system 1 can be used for example as a room divider system so that in a living space a furniture body 6 as shown in FIG. 2 in the form of a kitchen island, an office corner, a utility room, a shelf unit and so forth can be completely concealed by the door leaves 3a, 3b, 4a, 4b and can thus be visually separated from the remaining region of the living space.

The guide system 1 however can also be used for cupboard systems like for example a walk-in wardrobe. The mode of operation is described hereinafter with reference to the door leaves 3a and 3b, in which respect the same configurations are applicable for the door leaves 4a, 4b.

The door leaves 3a, 3b are moveable by the guide system 1 between a first position in which the door leaves 3a, 3b are oriented substantially in mutually coplanar relationship and in that case conceal the furniture body 6, and a second position in which the door leaves 3a, 3b are oriented in substantially mutually parallel relationship. In that second position the furniture body 6 is accessible for a person, wherein the two door leaves 3a, 3b can be received in an insertion shaft 7a disposed laterally beside the side wall 8a in such a way as to save space (the left-hand insertion shaft 7b for the other door leaves 4a, 4b can be better clearly seen from the drawing).

The guide system 1 includes a longitudinal guide rail 9 having a longitudinal direction L for guiding the door leaves 3a, 3b. That longitudinal guide rail 9 can be secured for example to the ceiling of a room, a wall of a room, or also to a furniture body, preferably parallel to a front side of the latter.

FIG. 3 shows an enlarged view of the region of the guide device 10, that is shown in FIG. 2. The first door leaf 3b is connected to a guide device 10, by which the door leaves 3a, 3b are mounted moveably along the longitudinal guide rail 9. It is possible to see a support 11 which is separate from the longitudinal guide rail 9, being in the form of a displaceable carriage which in a transfer position in the longitudinal direction L adjoins the longitudinal guide rail 9 in such a way that the guide device 10 connected to the first door leaf 3a is reciprocatingly transferable between the longitudinal guide rail 9 and the support 11. The guide device 10 can have at least a first roller 15a with a vertical axis of rotation for receiving lateral forces and at least a second roller 15b with a horizontal axis of rotation for receiving vertical forces, wherein the rollers 15a, 15b are mounted moveably along a profile portion 9a of the longitudinal guide rail 9, the portion 9a extending in the longitudinal direction L. The support 11 also has a receiving device 11a of a cross-section which corresponds to a shape and size of the profile portion 9a in respect of its cross-section so that the guide device 10 is reciprocatingly transferable between the longitudinal guide rail 9 and the support 11. The support 11 can for example have at least two guide channels 16a, 16b extending in the longitudinal direction L for guiding the rollers 15a, 15b.

The guide device 10 which is displaceable linearly along the longitudinal guide rail 9 is still on the longitudinal guide rail 9 in the illustrated transfer position of the support 11. The support 11 can be releasably locked to the longitudinal guide rail 9 in the transfer position, wherein that locking action can be released by the guide device 10 moving into or on to the support 11. After unlocking has occurred the support 11—together with the guide device 10 and the two door leaves 3a, 3b—is moveable in a horizontal direction, in a direction Z extending transversely, preferably at a right angle, relative to the longitudinal direction L of the longitudinal guide rail 9. The support 11 is connected to a vertically extending column 14 which is moveable in the direction Z and which is drivable at least portion-wise in the direction Z by a drive device 12. The column 14 is moveable in the direction Z along the second insertion rails 13a and 13b which in the mounted position are spaced from the longitudinal guide rail 9 in the heightwise direction.

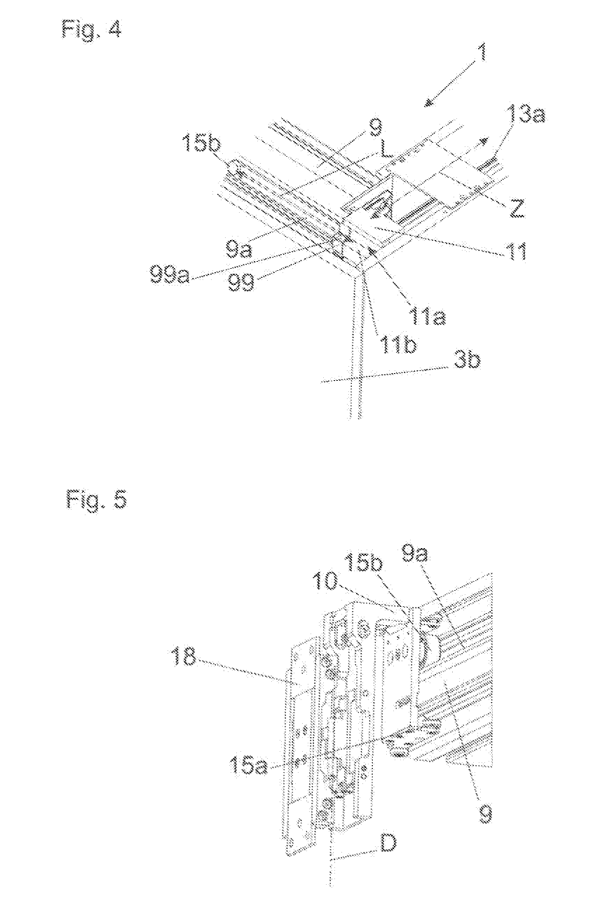

FIG. 4 shows the longitudinal guide rail 9 which provides a profile portion 9a. The at least one roller 15b is mounted moveably along same. The roller 15 is a component part of the guide device 10 (not visible in FIG. 4). The compensation device 99 is disposed at the end of the longitudinal guide rail 9. The compensation device 99 has a running surface 99a, along which the guide device 10 or a roller arranged on the guide device is displaceable.

The compensation device 99 is thus provided by a running surface 99a which is provided inclinedly relative to a profile portion 9a extending along the longitudinal guide rail 9. It can further be seen that the compensation device 99 is arranged in a region between the longitudinal guide rail 9 and the support 11 and/or the receiving device 11a, and that the guide device 10 or its roller 15b can be reciprocatingly transferred between the longitudinal guide rail 9 and the receiving device 11a by way of the compensation device 99.

The compensation device can also be provided in respect of a part thereof by the longitudinal guide rail 9 and in respect of a further part by the receiving device 11a. It can be seen from FIG. 4 that the compensation device 99 is provided by a part of the receiving device 11a. The receiving device 11a is in turn a component part of the support 11.

FIG. 5 shows the roller 15b which has a horizontal axis of rotation and which is mounted displaceably along the longitudinal guide rail 9 in the profile portion 9a. For stabilisation purposes the guide device 10 additionally has rollers 15a having a vertical axis of rotation. Arranged at the guide device 10 is a fitment 18 which is arranged moveably about the axis of rotation D and which is used to receive the furniture part 3. A furniture part arranged at that fitment 18 can thus be pivoted about the axis of rotation D and displaced along the longitudinal guide rail 9.

FIG. 6 shows a diagrammatic view illustrating the structure of the guide system 1 with the furniture part 3, in the form of the first door leaf 3b and the second door leaf 3a. The first door leaf 3b is arranged moveably on the column 14 by means of fitments 18. The second door leaf 3a is connected to the first door leaf 3b by way of central hinges 55. Disposed on the second door leaf 3a is the guide device 10 which is displaceable in the longitudinal direction L along the longitudinal guide rail 9. When the door leaves 3a,3b are pivoted relative to each other the guide device 10 moves along the longitudinal guide rail 9 on the profile portion 9a.

Disposed at the end of the longitudinal guide rail 9 and the profile portion 9a is the compensation device 99 which releases the roller 15b at the end of the longitudinal guide rail 9 and allows a certain heightwise play. That heightwise play or height difference X is compensated by the compensation device 99. Therefore, by virtue of the movement of the roller 15b thereonto, the compensation device 99 achieves a correct seat for the furniture part 3 in the closed position (as shown in FIG. 1a). The gap dimension between the furniture part 3 and for example the furniture body 37 is produced by way of passing over the compensation device 99 in the direction of the closed position. In the open position (FIG. 1b) or insertion position (FIG. 1c) that correct positioning of the furniture part 3 or the door leaves 3a, 3b in the correct heightwise position is no longer required. The furniture part 3 should have a little play in order to be able to be fitted or placed in the insertion shaft 7a.

The height difference X occurs due to the adjustability of the column 14 as shown by the arrow VH. In addition the furniture part 3 or the first door leaf 3b is also adjustable in its position by the fitment 18, which is shown by the arrow VS. The central hinge 55 for connecting the two door leaves 3a, 3b is also adjustable, which is shown by the arrow VM. Those differing adjustment options VM, VS and VH alter the height difference X and have to be compensated in the movement from the closed position into the open position. In that case the guide device 10 or the roller 15b arranged thereon, in the open position, can come into contact with the support 11 or the receiving device 11a arranged thereon or can be positioned floating freely over same or in same.

It is therefore provided that the receiving device 11a has a running surface 11b. The situation can occur where the at least one guide device 10, upon positioning in the receiving device 11a, contacts the running surface 11b or is at a spacing relative to the running surface 11b. In the return movement into the closed position that height difference X has to be overcome by way of the compensation device 99. The guide device 10 or the at least one roller 15b arranged thereon can travel back on to the longitudinal guide rail 9 by way of the compensation device 99 which is in the form of an inclined profile portion 99a or ramp, in which case the correct heightwise position and thus the correct gap dimension is achieved.

In that respect the compensation device 99 extends over a maximum of a third along the length of the receiving device 11a, the receiving device 11a being provided by the support 11.

It would also be possible for the compensation device 99 to be arranged on the longitudinal guide rail 9. It can also be seen that the compensation device 99 is provided by a ramp which extends in falling relationship from the longitudinal guide rail 9 in the direction of the receiving device 11a.

The at least one roller 15b of the guide device 10 is thus reciprocatingly transferable between the longitudinal guide rail 9 and the receiving device 11a by way of that compensation device 99. The support 11 and/or the receiving device 11a is arranged at the top side of the vertically extending column 14, the furniture part 3 comprising the first and second door leaves 3a, 3b is secured moveably to the column 14 about the axis of rotation D by at least one fitment 18. In that arrangement the guide device 10 is connected to one of the door leaves 3a, 3b and provides for longitudinal guidance of the door leaves 3a, 3b in the pivotal movement from the open position into the closed position and vice-versa.

Another kind of compensation device 99 would be conceivable for example by means of a moveable flap or rocker mounted moveably between the two heightwise positions for compensating for the height difference X. Instead of a ramp which extends straight it is also possible to provide a curve.

FIG. 7 shows the door leaves 3a, 3b in an open position (as in FIG. 1b). In that arrangement the at least one roller 15b of the guide device 10 is arranged in the support 11, and the support 11 thus supports the moveable furniture part 3. Before that receiving situation the roller 15b is transferred from the longitudinal guide rail 9 into the receiving device 11a of the support 11 by way of the compensation device 99.

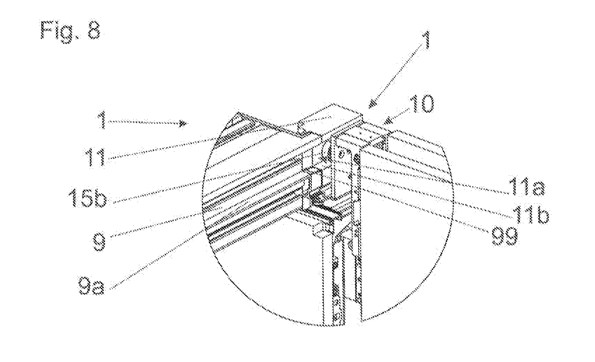

FIG. 8 shows in detail how the roller 15b is received in the receiving device 11a. If the furniture part 3 or the first and second door leaves 3a, 3b, as shown in FIG. 7, were moved from that open position into a closed position then the compensation device 99 which is in the form of a ramp, depending on the setting of the heightwise play X, would cause lifting movement of the at least one roller 15b or would compensate for the lifted position which has already been achieved by virtue of an adjustment. That affords collision-free return guidance of the guide device 10 out of the receiving device 11a by way of the compensation device 99 on to the longitudinal guide rail 9 and the profile portion 9a thereof. The height difference X is compensated by the compensation device 99 in the form of a ramp. In addition the ramp affords a kind of insertion aid for the roller 15b and thus for the guide device 10 in passing from the profile portion 9a into the receiving device 11a.

1. A guide system for guiding a moveably mounted furniture part, in particular a folding or folding-sliding door, including:
a longitudinal guide rail,
at least one guide device, by way of which the furniture part is moveable in a longitudinal direction along the longitudinal guide rail, and
at least one support on which the furniture part is hingedly mounted, wherein the at least one support is moveable in a direction extending transversely relative to the longitudinal direction of the longitudinal guide rail,
wherein the at least one support has a receiving device for receiving the guide device and the support is moveable in the mounted position into a transfer position in which the receiving device is arranged adjacent to the longitudinal guide rail and there is provided a compensation device for compensating for a height difference between the receiving device and the longitudinal guide rail.

2. The guide system according to claim 1, wherein the compensation device is arranged in a region between the longitudinal guide rail and the support and/or the receiving device and the guide device is reciprocatingly transferable between the longitudinal guide rail and the receiving device by way of the compensation device.

3. The guide system according to claim 1, wherein the compensation device is provided by a running surface provided inclinedly relative to a profile portion extending along the longitudinal guide rail.

4. The guide system according to claim 1, wherein the compensation device is arranged on the support and/or on the longitudinal guide rail.

5. The guide system according to claim 1, wherein the compensation device is provided by a part of the receiving device.

6. The guide system according to claim 5, wherein the compensation device extends over a maximum of a third along the length of the receiving device.

7. The guide system according to claim 1, wherein the compensation device is provided by a ramp extending in falling relationship from the longitudinal guide rail in the direction of the receiving device.

8. The guide system according to claim 1, wherein the guide device has at least one roller, wherein the at least one roller is reciprocatingly transferable between the longitudinal guide rail and the receiving device by way of the compensation device.

9. The guide system according to claim 1, wherein the support and/or the receiving device is arranged at the top side of a vertically extending column, wherein the furniture part is fixed to the column moveably about an axis of rotation by at least one fitment.

10. The guide system according to claim 1, wherein the furniture part is provided by a first door leaf and a second door leaf, wherein the door leaves are connected together hingedly by way of at least one central hinge so that the furniture part is formed by a folding-sliding door.

11. The guide system according to claim 1, wherein the receiving device has a running surface and the at least one guide device upon positioning in the receiving device contacts the running surface or is at a spacing relative to the running surface.

12. The guide system according to claim 1, wherein the guide system has at least one insertion rail, along which the at least one support or a column arranged on the support is moveable in a direction extending transversely relative to the longitudinal direction of the longitudinal guide rail.

13. An article of furniture having a guide system according to claim 1.

14. The article of furniture according to claim 13, wherein the article of furniture has a body which is fixed in operation and at least two furniture parts which are mounted moveably relative to the furniture body, in particular door leaves of a folding door or folding-sliding door, which in the mounted position are connected hingedly together by way of a vertically extending axis of rotation, wherein the at least two furniture parts are moveable by the guide system between a first position in which the furniture parts are oriented in substantially mutually coplanar relationship and a second position in which the furniture parts are oriented in substantially mutually parallel relationship.

15. The article of furniture according to claim 14, wherein the article of furniture has at least one lateral insertion shaft in which the furniture parts are received in the second position.

16. The article of furniture according to claim 14, wherein there is provided at least one further furniture body which is fitted into the furniture body or is connected to the furniture body, wherein the further furniture body is concealed by the moveable furniture parts in the first position and is accessible in the second position.
